(19) United States
(12) Patent Application Publication
(10) Pub. No.: US 2009/0042716 A1
(43) Pub. Date: Feb. 12, 2009

(54) High Temperature Reactor for the Poduction of Nanophase WC/CO Powder

(75) Inventors: Bernard H. Kear, Whitehouse Station, NJ (US); Ganesh Skandan, Easton, PA (US); Peter R. Witting, West Seneca, NY (US)

Correspondence Address: Kenneth Watov;WATOV & KIPNES, Post Office Box 247, Princeton Juncton, NJ, 08550, US

(73) Assignee: RUTGERS, THE STATE UNIVERSITY OF NEW JERSEY, New Brunswick, NJ (US)

(21) Appl. No.: 12/083,468

(22) PCT Filed: Nov. 2, 2006
(86) PCT No.: PCT/US2006/042834

§ 371 Date: Apr. 11, 2008

Related U.S. Application Data
(60) Provisional application No. 60/733,198, filed on Nov. 4, 2005.

(51) Int. Cl. C04B 35/567; H05F 3/00; B01J 19/08

(52) U.S. Cl. 501/87; 501/94; 204/164; 422/186.04

(57) ABSTRACT

A method for producing a nanostructured cermet material, including the steps of preparing an aqueous solution mixture of precursor compounds of the cermet material, introducing the solution mixture into a heated tubular reactor in the form of a fine-particle aerosol, and processing the solution mixture in the heated tubular reactor to form the nanostructured cermet material. The present invention is further directed to a processing apparatus configured for implementing the present method.

### FIELD OF THE INVENTION

The present invention relates generally to composite materials, and more specifically to nanophase cermet materials and methods for producing the same.

### BACKGROUND OF THE INVENTION

For several decades, the hard metal industry has introduced progressively finer grades of cermet materials including tungsten carbide/cobalt (WC/Co) cemented carbides for machine tool and wear part applications. This trend is driven by the recognition that finer grades of hard metals exhibit superior mechanical performance. While sub-micron grades of WC/Co, with WC grain size of about 0.5 μm, still dominate today's market for cemented carbides, there is a growing demand for even finer grades that are about 0.1 μm for some applications such as, for example, tools for cutting plastics, composite printed circuit boards, and aluminum silicate (Al—Si) alloys. For such applications, the ability of the tool to maintain a very sharp cutting edge over an extended service life is important and very desirable. Experience has shown that ultra-fine grades of WC/Co satisfy these requirements, because of their higher hardness and improved fracture toughness.

Various chemical methods for synthesizing nanophase WC/Co powders have been introduced in attempts to meet the market demands. One particular method involves a three-step fluid-bed process called spray conversion processing (SCP). This process is known in the art for the production of micron-sized powders such as nanophase WC/Co powders. The spray conversion processing involves: (1) dissolving ammonium metatungstate and cobalt acetate in water to fix the composition of a starting solution; (2) spray drying to transform that solution into an amorphous precursor powder; and (3) utilizing fluid-bed conversion (pyrolysis, reduction and carburization) of the precursor powder to form nanophase WC/Co powder. The last step in the processing requires about 8 hours at 800-900° C. to complete, and thus is a major factor in powder production cost.

Accordingly, there is a pressing need in the art to develop an apparatus and methods for substantially reducing the time required to produce the aforesaid materials, while enabling further reduction in particle sizes to yield finer grades of cermet materials with superior qualities.

### SUMMARY OF THE INVENTION

A method is described for the production of a cermet material in the form of a nanophase tungsten carbide/cobalt (WC/Co) powder. The present method utilizes thermochemical conversion of an aqueous-solution precursor in a high temperature tubular reactor. The solution precursor preferably comprises tungsten and cobalt salts in the presence of a soluble carbon source, such as, for example, sucrose. To achieve rapid and efficient conversion of the solution precursor to nano-WC/Co powder, the precursor is preferably delivered to the tubular reactor in the form of a fine-particle aerosol. To achieve proper carbon balance, the as-synthesized powder is post-annealed in a flowing gas stream of controlled carbon activity. A slurry of micron-sized WC particles in a solution precursor may also be used as feed material, in which case the product powder has a “bimodal” composite structure. When processed as a coating or bulk material, such bimodal-structured WC/Co displays superior abrasive-wear properties.

In a preferred embodiment of the present invention, a plasma torch is incorporated into a resistively-heated tubular graphite reactor to obtain temperatures of up to 3000° C. The net effect is that precursor pyrolysis, reduction and carburization can be accomplished in a single operation with processing times measured in seconds rather than hours, because of the very fast conversion kinetics at such high temperatures.

In one aspect of the present invention, there is provided a method for producing a nanostructured cermet material, comprising the steps of:

preparing an aqueous solution mixture of precursor compounds of the cermet material; and

processing the solution mixture in a heated tubular reactor to form the nanostructured cermet material.

In another aspect of the present invention, there is provided a processing apparatus for producing a nanostructured cermet material, comprising:

a reactor tube having an inlet at one end, and an outlet at the other end;

at least one high enthalpy plasma torch for directing a plasma flame into the inlet of the reactor tube;

at least one precursor feed for supplying an aqueous solution mixture of precursor compounds of the cermet material into the inlet of the reactor tube; and

at least one heating element surrounding at least a portion of the reactor tube for generating heat in the reactor tube.

### BRIEF DESCRIPTION OF THE DRAWINGS

The following drawings, in which like items may have the same reference designations, are illustrative of embodiments of the present invention and are not intended to limit the invention as encompassed by the claims forming part of the application, wherein:

FIG. 1 is a longitudinal cross-sectional diagram of a processing apparatus for an embodiment of the present invention.

### DETAILED DESCRIPTION OF THE INVENTION

The present method utilizes thermochemical conversion of an aqueous-solution precursor in a high temperature tubular reactor. The solution precursor preferably comprises tungsten and cobalt salts in the presence of a water soluble carbon compound, such as, for example, sucrose. To achieve rapid and efficient conversion of the solution precursor to nano-WC/Co powder, the precursor is preferably delivered to the tubular reactor in the form of a fine-particle aerosol. In a preferred form, the fine-particle aerosol comprises an average particle size of less than 1.0 μm, and more preferably from about 0.1 μm to 1.0 μm. To achieve proper carbon balance, the as-synthesized powder is post-annealed in a flowing gas stream of controlled carbon activity. A slurry of micron-sized WC particles in a solution precursor may also be used as feed material, in which case the product powder has a “bimodal” composite structure. When processed as a coating or bulk material, such bimodal-structured WC/Co displays superior abrasive-wear properties.

In comparison to the original fluid-bed process of the prior art and an embodiment of the present invention utilizing a tubular-reactor process is that the former generates micron-sized nanophase WC/Co powder, whereas the latter generates submicron-sized nanophase WC/Co powder. Also, in another embodiment of the present invention, a spray drying treatment is used to convert the fine-scale powder into particle-aggregates ranging from about 20 to 50 μm suitable for thermal spraying of coatings or liquid-phase sintering of bulk parts. The spray drying treatment can further include heat treating the fine-scale powder.

Accordingly, two methods of the present invention are described for the production of nanophase WC/Co powder, starting with an aerosol-solution precursor. In one embodiment of the present invention, the solution precursor is injected into a resistively- or inductively-heated tubular reactor, where nano-WC/Co powder is formed by controlled thermochemical processing of the precursor feed material. In another embodiment of the present invention, the heated tubular reactor is modified by incorporating a high enthalpy plasma torch as an additional heat source, thus enabling higher processing temperatures, faster precursor decomposition kinetics, and hence higher powder production rates.

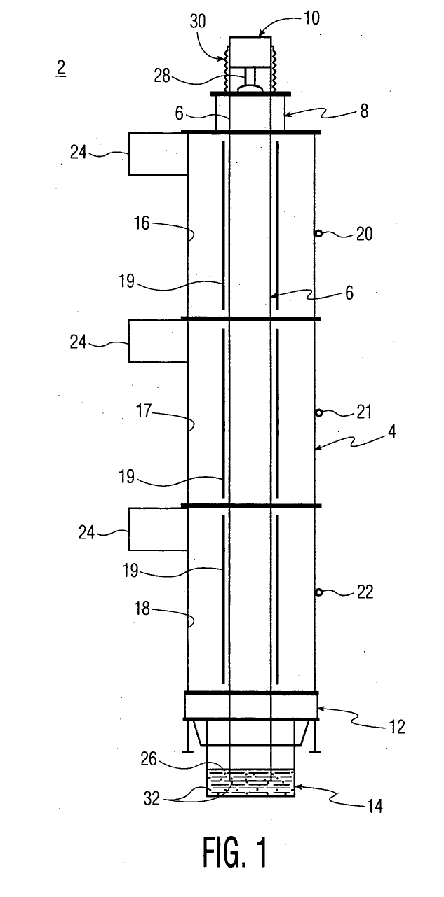

FIG. 1 shows a cross-sectional diagram of a processing apparatus 2 for one embodiment of the present invention. The processing apparatus 2 includes a housing 4 enclosing an elongated reactor tube 6, an entrance feed chamber 8 mounted on the top of the housing 4 for feeding a precursor material stream into the reactor tube 6, a spray fed or shrouded DC-arc plasma feed system 10 mounted on top of the entrance feed chamber 8, an exit heating section 12 at the bottom of the housing 4, and either a water quench bath container or dust extractor 14 mounted on the latter. The reactor tube 6 can be composed of a refractory material that is heat- and thermal-shock resistant material such as, for example, ceramics, graphite, silicon carbide and the like.

The housing 4 includes three zones 16, 17, 18, respectively. Each zone 16, 17, 18, respectively, includes a heating element 19 surrounding a corresponding portion of the reactor tube 6 within the associated zones for providing resistive- or inductive-heating. The heating element 19 can be composed of suitable resistive- or inductive-heating materials such as, for example, graphite. Temperature measuring ports 20, 21, and 22 are provided in each zone 16, 17 and 18, respectively. Supports 24 are provided in each zone 16, 17, 18, for retaining the apparatus 2 in an upright position that is vertically oriented along its longitudinal axis. Also, a bellows 30 surrounds the plasma feed system 10 as shown.

The present apparatus 2 is zone-heated with the graphite heating elements 19 that surround the reactor tube 6, allowing process temperatures to reach up to 3000° C. During the relatively short exposure times of the aerosol feed particles or stream (not shown) to the hot zones 16, 17, 18 of the processing apparatus 2, rapid conversion to nano-WC/Co powder occurs. The as-synthesized powder 32 is collected by quenching the particles in a bath of cold water 26 or by venting the particles to a system of dust extractors.

In the processing apparatus 2, a high enthalpy plasma torch 28 included in the plasma feed system 10 is attached to the top of the resistively-heated reactor tube 6 as shown in FIG. 1. As a result, very high reactor processing temperatures can be maintained, thus enabling high powder production rates in time periods of less than one minute, and more specifically measured in seconds. Without the additional thermal energy derived from the plasma flame (not shown), the aerosol feed tends to cool the central region or zone 17 of the reactor tube 6, thus significantly lowering the processing temperature and reducing the powder production rate.

After an initial pyrolysis reaction to form a highly porous mixture of W/Co-rich oxide phases, the highly porous mixture of W/Co-rich oxide phases is thereafter subjected to a post-annealing treatment to achieve proper carbon balance. The pyrolyzed powder is further exposed to a gas stream comprising a reducing agent such as, for example, CO/CO₂ or CO/H₂. The pyrolized powder is reduced in H₂ and carburized in a CO/CO₂ (or CO/H₂) gas mixture of controlled carbon activity; the latter is generally fixed at about a_{c}˜0.98 to ensure that the final powder product contains stoichiometric WC phase only and no free carbon. In the present tubular reactor process and apparatus 2, because of the much higher temperature involved, and the fact that all three components (tungsten salt, cobalt salt and carbon compound) are already present in the aerosol-solution precursor, rapid conversion to nano-WC/Co is accomplished. In a preferred embodiment, the tungsten salt is ammonium metatungstate, the cobalt salt is cobalt acetate and the carbon compound is a hydrocarbon such as, for example, sucrose.

Because of the complexity of the chemical reactions involved in the thermal decomposition and reaction of the aerosol-solution precursor, only an approximate estimate can be made of the initial sucrose concentration (i.e., water soluble carbon compound or source) needed to ensure complete conversion to nano-WC/Co powder. However, by an iterative process, an optimal starting composition can be determined, provided that all critical processing parameters are kept constant. Amongst these are solution-precursor concentration and feed rate, reactor temperature and residence time, and gas phase composition. To promote the carburization reaction, methane may also be used as a carrier gas for the aerosol-solution precursor. To produce a bimodal-structured WC/Co powder, a similar procedure is used, except that the aerosol feed is composed of a slurry or suspension of fine WC particles in a solution precursor.

As noted above, as-synthesized submicron-sized WC/Co powder often needs to be converted into fine-particle aggregates, suitable for subsequent use in thermal spraying of coatings or liquid-phase sintering of bulk parts. This is done by wet-milling the as-synthesized powder with a binder phase, spray drying to form fine-particle aggregates, and heat treatment to eliminate the binder phase and to impart some structural strength to the particle aggregates—otherwise they tend to disintegrate during spraying or handling. This last step is best carried out in a controlled activity gas stream (ac˜0.98) to achieve proper carbon balance in the final powder product.

To fabricate a hard, wear-resistant nanophase WC/Co coating by thermal spraying, experience has shown that the optimal feedstock powder comprises about a 70:30 blend of phase-pure WC and nanophase WC/Co powders. The resulting “bimodal-structured” WC/Co coating displays superior abrasive-wear properties. On the other hand, to fabricate a nanophase WC/Co bulk part by liquid-phase sintering, a major challenge is to mitigate grain growth during sintering. This is best accomplished by making an addition of up to and about 1 wt. % of a known grain growth inhibitor, such as, for example, vanadium carbide (VC) or chromium carbide (Cr₃C₂).

The present inventors recognize that the incorporation of a DC arc-plasma torch into a resistively- or inductively-heated tubular reactor creates a very efficient and improved powder processing apparatus 2. In a preferred embodiment of the present invention, a symmetrical arrangement of two or more plasma torches 28 with an axial feed-particle delivery system, is attached to the top of the housing 4. Since this arrangement combines the heating effects of reactor and plasma, very high powder production rates can be achieved. The high temperature capability of the present system can also be applied to processing of refractory oxide phases, which cannot be done effectively in a resistively- or inductively-heated reactor tube alone.

Note that, because of the very high temperatures attainable in the present apparatus 2, almost any feed material can be completely vaporized. By attaching a supersonic nozzle (not shown) to the lower end of the reactor tube 6, nanoparticles can be formed in the adiabatic cooling zone near the exit of the nozzle. By directing these very hot nanoparticles onto a moderately-heated substrate or mandrel (not shown), various shapes and forms can be fabricated. For example, the aforesaid spray forming of the present invention can be used to produce nano-ceramic armor plate, including multi-layered armor designed for multi-hit capability.

Although various embodiments of the invention have been shown and described, they are not meant to be limiting. Those of skill in the art may recognize certain modifications to the invention as taught, which modifications are meant to be covered by the spirit and scope of the appended claims.

What is claimed is:

1. A method for producing a nanostructured cermet material, comprising the steps of:
preparing an aqueous solution mixture of precursor compounds of the cermet material; and
processing the solution mixture in a heated tubular reactor to form the nanostructured cermet material.

2. The method of claim 1, further comprising introducing the solution mixture into the heated tubular reactor in the form of a fine-particle aerosol.

3. The method of claim 2, wherein the fine-particle aerosol includes an average particle size of less than 1.0 μm.

4. The method of claim 3, wherein the average particle size is from about 0.1 μm to 1.0 μm.

5. The method of claim 2, wherein the nanostructured cermet material is in the form of a powder.

6. The method of claim 5, further comprising:
spray drying the powder nanostructured cermet material; and
heat treating the powder nanostructured cermet material to form an aggregated powder.

7. The method of claim 6, wherein the aggregated powder exhibits an average particle size of from about 20 to 50 μm.

8. The method of claim 1, wherein the cermet material is tungsten carbide/cobalt.

9. The method of claim 8, wherein the aqueous solution mixture includes a tungsten salt and a cobalt salt in the presence of a carbon compound.

10. The method of claim 9, wherein the tungsten salt is ammonium metatungstate.

11. The method of claim 9, wherein the cobalt salt is cobalt acetate.

12. The method of claim 9, wherein the carbon compound is a hydrocarbon.

13. The method of claim 12, wherein the hydrocarbon is sucrose.

14. The method of claim 1, further comprising post-annealing the nanostructured cermet material to achieve proper carbon balance.

15. The method of claim 14, further comprising exposing the nanostructured cermet material to a gas stream a reducing agent with a controlled carbon activity of about 0.98 to yield stochiometric tungsten carbide phase, and eliminate free carbon.

16. The method of claim 15, wherein the reducing agent is selected from the group consisting of CO/CO₂, CO/H₂, or combinations thereof.

17. The method of claim 1, wherein the aqueous solution mixture includes a slurry or suspension of tungsten carbide particles.

18. The method of claim 17, wherein the nanostructured cermet material is a bi-modal structure tungsten carbide/cobalt.

19. The method of claim 1, wherein the tubular reactor includes:
a reactor tube having an inlet at one end, and an outlet at the other end;
at least one high enthalpy plasma torch for directing a plasma flame into the inlet of the reactor tube;
at least one precursor feed for supplying the aqueous solution mixture into the inlet of the reactor tube; and
at least one heating element surrounding at least a portion of the reactor tube for generating heat in the reactor tube.

20. The method of claim 19, wherein the heating element is selected from the group consisting of resistive heating elements, inductive heating elements and combinations thereof.

21. The method of claim 19, wherein the plasma torch, heating element, and reactor tube are configured to maintain a reactor temperature of up and about 3,000° C.

22. The method of claim 19, wherein the reactor tube is composed of a refractory, heat- and thermal-shock resistant material.

23. The method of claim 22, wherein the refractory, heat- and thermal-shock resistant material is selected from the group consisting of graphite, silicon carbide and combinations thereof.

24. The method of claim 19, wherein the precursor feed is configured to supply the aqueous solution mixture in the form of a fine particle aerosol.

25. A processing apparatus for producing a nanostructured cermet material, comprising:
a reactor tube having an inlet at one end, and an outlet at the other end;
at least one high enthalpy plasma torch for directing a plasma flame into the inlet of the reactor tube;
at least one precursor feed for supplying an aqueous solution mixture of precursor compounds of the cermet material into the inlet of the reactor tube; and
at least one heating element surrounding at least a portion of the reactor tube for generating heat in the reactor tube.

26. The processing apparatus of claim 25, wherein the heating element is selected from the group consisting of resistive heating elements, inductive heating elements and combinations thereof.

27. The processing apparatus of claim 25, wherein the plasma torch, heating element, and reactor tube are configured to maintain a reactor temperature of up and about 3,000° C.

28. The processing apparatus of claim 25, wherein the reactor tube is composed of a refractory, heat- and thermal-shock resistant material.

29. The processing apparatus of claim 28, wherein the refractory, heat- and thermal-shock resistant material is selected from the group consisting of graphite, silicon carbide and combinations thereof.

30. The processing apparatus of claim 25, wherein the precursor feed is configured to supply the aqueous solution mixture in the form of a fine particle aerosol.

31. The processing apparatus of claim 25, further comprising a collecting means located at the outlet of the reactor tube for collecting the nanostructured cermet material.
